(19) United States
(12) Patent Application Publication
(10) Pub. No.: US 2008/0178280 A1
(43) Pub. Date: Jul. 24, 2008

(54) Method for Preventing Electronic Devices from Unauthorized Switching On

(76) Inventor: Shoei-Lai Chen, Taipei (TW)

Correspondence Address: HDSL, 4331 STEVENS BATTLE LANE, FAIRFAX, VA, 22033, US

(21) Appl. No.: 12/056,416

(22) Filed: Mar. 27, 2008

Related U.S. Application Data
(63) Continuation-in-part of application No. 11/014,589, filed on Dec. 16, 2004.

(51) Int. Cl. G06F 21/00; G06F 1/26

(52) U.S. Cl. 726/16; 713/300

(57) ABSTRACT

A method for preventing an electronic device from unauthorized switching on by changing power button is disclosed. After a user operates the default power button to switch on the electronic device 1, the user sets the electronic device into a setting mode. The user designates at least one button of the function buttons to be a new power button. The new power button functionally replaces the default power button after the setting mode is finished. Thus the electronic device can be switched on only by the new power button.

### RELATED APPLICATION

This is a continuation-in-part application Ser. No. 11/014,589, filed Dec. 16, 2004.

### BACKGROUND OF THE INVENTION

1. Field of the Invention

The present invention relates to power management for electronic devices, and more particularly to a method of preventing from unauthorized switching on.

2. Description of Prior Art

Portable electronic devices, such as mobile phones, digital cameras, lap-top computers, global positioning systems (GPS) and personal digital assistants (PDA) have become more and more popular. Such devices are usually equipped with memory for storing personal information. The information stored in the portable devices may be very private or confidential. Once the device is lost by the owner or is illegally unauthorized accessed by someone else, the information in the device will be in potential danger.

To avoid the problem of unauthorized access, some conventional electronic devices provide a password function. The device can not perform any function if a correct password has not been input. Sometimes, the passwords are easy to be broken. Besides, other security mechanisms of personal biological identification, such as fingerprints, voices or retinas, have been proposed to provide better authentication to the electronic devices. However, the cost and the size of the electronic devices will be inevitably increased.

### SUMMARY OF THE INVENTION

The primary object of the present invention is to provide a method for preventing electronic devices from unauthorized switching on, which allows a user to change the default power button with other one or more function buttons. The self-set power button(s) can functionally replace the default power button, so that the electronic devices can prevent from unauthorized switching on because an unauthorized user can not know what the new power buttons are.

Another object of the present invention is to provide a method for preventing electronic devices from unauthorized switching on by replacing the default power button with newly self-set power buttons, which is hard to be broken because the new power buttons are meaningless and can be pressed simultaneously or serially.

Another object of the present invention is to provide a method for preventing electronic devices from unauthorized switching on, which only uses existing elements and does not increase the cost or size of the electronic devices.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a symbolic view of a portable electronic device 1 having a button pad; and

FIG. 2 shows a flowchart of the method for preventing electronic devices from unauthorized switching on according to a preferred embodiment of the present invention.

### DETAILED DESCRIPTION OF THE INVENTION

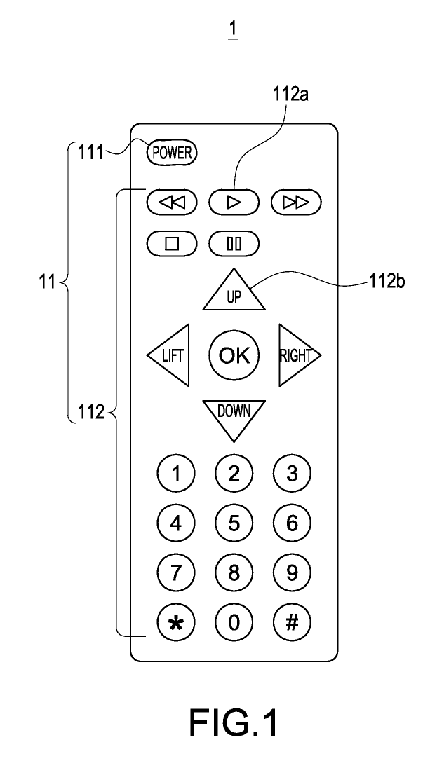

FIG. 1 shows a symbolic view of a portable electronic device 1. The electronic device 1 in the shown embodiment can be a mobile phone, portable computer, GPS or PDA, etc. The electronic device 1 has a button pad 11 arranged on one side thereof. The button pad 11 is composed of a plurality of buttons including a power button 111 and other function buttons 112. The power button 111 marking the term “POWER” is a default of the manufacture, which is used to switch on/off power of the electronic device 1. The term “POWER” marked on the button is just a typical indication. Any other terms or symbols which can stand for the same meaning are also available. The function buttons 112 indicate all buttons of the button pad 11 except the power buttons 111, such as numbers, directions and play controls.

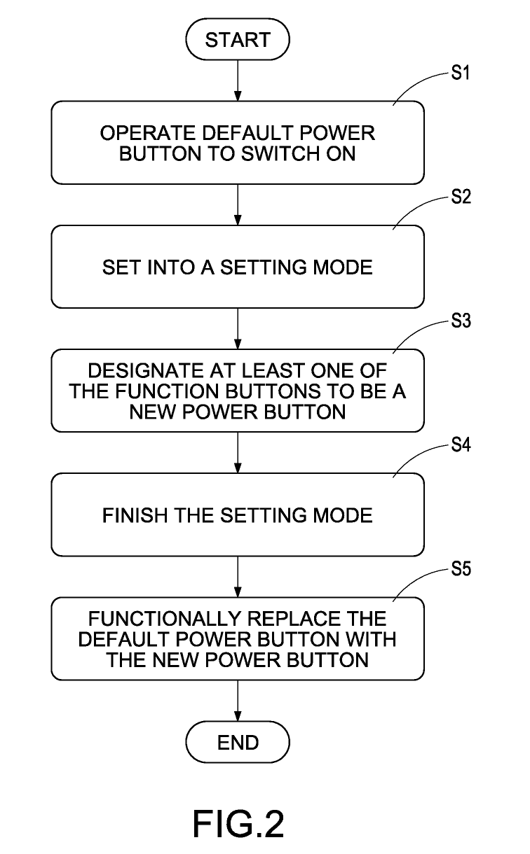

FIG. 2 shows a flowchart of the method for preventing electronic devices from unauthorized switching on according to one preferred embodiment of the present invention. First, a user operates the default power button 111 to switch on the electronic device 1 in step S1. Secondly, the user sets the electronic device 1 into a setting mode in step S2. The setting mode is a mode allowing the user to change the default power button 111. Next, the user designates at least one button of the function buttons 112 to be a new power button in step S3. Then, the user finishes the setting mode in step S4. Finally, the new power button functionally replaces the default power button 111 in step S5. In other words, the default power button 111 is not capable of switching on/off any longer even if it is still marked “POWER”. The newly self-set power button can be a single button or a combination of two or more buttons. After step S5 is accomplished, the electronic device 1 can be switched on only by pressing the newly power button(s).

To give an example by FIG. 1, when the user designates the PLAY button 112a as the new power button, the PLAY button 112a will functionally replace the default power button 111. If the user designates both the PLAY button 112a and the upward direction button 112b as the new power buttons, then the two buttons jointly perform the powering function. Moreover, the combination composed of a plurality of buttons can be arranged simultaneously or serially. In detail, the user can set the new power buttons to switch on by means of simultaneously or serially pressing. Once the user finishes setting the new power button(s), the new power button(s) will not be known by anyone else except the owner or authorized users. It is very difficult or even impossible to switch on the electronic device 1.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for preventing an electronic device from unauthorized switching on, the electronic device having a buttons pad including a default power button and other function buttons, the method comprising the steps of:
operating the default power button to switch on the electronic device;
setting the electronic device into a setting mode;
designating at least one of the function buttons to be a new power button;
finishing the setting mode; and
functionally replacing the default power button with the new power button.

2. The method as in claim 1, wherein the new power button is single.

3. The method as in claim 1, wherein the new power button is a combination of two or more buttons.

4. The method as in claim 3, wherein the new power button being a combination of two or more buttons is performed by simultaneously operating.

5. The method as in claim 3, wherein the new power button being a combination of two or more buttons is performed by sequentially operating.
